(19) United States
(12) Patent Application Publication
(10) Pub. No.: US 2024/0209201 A1
(43) Pub. Date: Jun. 27, 2024

(54) BLEND COMPOSITION WITH IMPROVED PLASTICITY PERFORMANCE AND METHOD FOR PREPARING THE SAME

(71) Applicants: Eco-Poly Co., Ltd., Suwon-si (KR); RESEARCH & BUSINESS FOUNDATION SUNGKYUNKWAN UNIVERSITY, Suwon-si (KR)

(72) Inventors: Jong Hwan SUHR, Suwon-si (KR); Hye Jung YOON, Anyang-si (KR); Seung Hyun CHO, Suwon-si (KR); Bum Yong YOON, Suwon-si (KR); Eun Young OH, Suwon-si (KR)

(73) Assignees: Eco-Poly Co., Ltd., Suwon-si (KR); RESEARCH & BUSINESS FOUNDATION SUNGKYUNKWAN UNIVERSITY, Suwon-si (KR)

(21) Appl. No.: 18/521,200

(22) Filed: Nov. 28, 2023

(30) Foreign Application Priority Data
Dec. 26, 2022 (KR) 10-2022-0184875

(51) Int. Cl. C08L 35/02; C08J 3/00; C08J 3/24

(52) U.S. Cl. CPC C08L 35/02; C08J 3/005; C08J 3/24; C08J 2335/02; C08L 2205/02

(57) ABSTRACT

Disclosed are a blend composition with improved plasticity performance and a method for preparing the same. The blend composition with improved plasticity performance includes a first component containing suberin or a suberin-based compound; and a second component containing polylactic acid (PLA).

### CROSS-REFERENCE TO RELATED APPLICATION

This application claims a benefit under 35 U.S.C. § 119(a) of Korean Patent Application No. 10-2022-0184875 filed on Dec. 12, 2022, on the Korean Intellectual Property Office, the entire disclosure of which is incorporated herein by reference for all purposes.

### BACKGROUND

### 1. Field

The present disclosure relates to a blend composition with improved plasticity performance and a method for preparing the same.

### 2. Description of Related Art

Polylactic acid (PLA) as the most widely used existing biodegradable plastic is a synthetic polymer that may be prepared by extracting starch from corn. PLA is the most widely used among biodegradable plastics due to its low price and high productivity. However, PLA is one of the plastics with a low biodegradation rate among biodegradable plastics, and has a high biodegradation rate only when certain conditions are met. Accordingly, in order to improve the biodegradability of the PLA, the PLA is mixed with additives such as bioplastics such as PHA (polyhydroxyalkanoates) and PBAT (polybutylene adipate-co-terephthalate), which are biodegrade in a faster manner than PLA is. However, such additives are significantly less price-competitive in terms of productivity and production cost due to bio processes using microorganisms, and have reduced mechanical properties due to low compatibility.

### SUMMARY

A purpose of the present disclosure is to provide a blend composition that has excellent processability and improved plasticity performance along with high biodegradability.

Another purpose of the present disclosure is to provide a method for preparing the blend composition.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

A first aspect of the present disclosure provides a blend composition with improved plasticity performance, the blend composition comprising: a first component containing suberin or a suberin-based compound; and a second component containing polylactic acid (PLA).

According to some embodiments of the blend composition with improved plasticity performance, the first component is extracted from a plant or a process product of the plant.

According to some embodiments of the blend composition with improved plasticity performance, the first component is extracted from a cork and/or a potato periderm.

According to some embodiments of the blend composition with improved plasticity performance, the first component is extracted from the cork and the potato periderm, wherein the first component extracted from cork and the first component extracted from the potato periderm have a weight ratio of 2:1 to 3:1.

According to some embodiments of the blend composition with improved plasticity performance, the first component and the second component have a weight ratio of 10:90 to 1:99.

A second aspect of the present disclosure provides a method for preparing a blend composition with improved plasticity performance, the method comprising: blending a first component containing suberin or a suberin-based compound and a second component containing polylactic acid with each other.

According to some embodiments of the method, the first component and the second component are blended with each other at a weight ratio of 10:90 to 1:99.

According to some embodiments of the method, the method further comprises extracting the first component from a plant or a processed product of the plant.

According to some embodiments of the method, the first component is extracted from a cork and/or a potato periderm.

According to some embodiments of the method, the first component is extracted from the cork and the potato periderm, wherein the cork and the potato periderm from which the first component is to be extracted are prepared at a weight ratio of 4:6 to 6:4.

According to some embodiments of the method, the first component is extracted from the cork and the potato periderm by hydrolyzing the cork and/or the potato periderm and then performing polycondensation on the hydrolyzed cork and/or the hydrolyzed potato periderm.

According to some embodiments of the method, the hydrolysis is carried out by adding a hydrolysis solution containing ethanol and sodium hydroxide to the cork and/or the potato periderm.

According to some embodiments of the method, the polycondensation is carried out at 80 to 120° C. for 36 to 60 hours.

According to some embodiments of the method, the blending is carried out at 160 to 200° C. for 5 minutes or greater.

According to some embodiments of the method, the method further comprises performing twin-screw extruding of a blending result while heating the blending result at 170 to 200° C. and cooling the blending result alternately with each other.

The blend composition according to an embodiment of the present disclosure may have high biodegradability, processability, and plasticity performance.

The method for preparing the blend composition according to an embodiment of the present disclosure may provide the blend composition having high biodegradability, processability, and plasticity performance.

Based on this technology, the blend composition according to an embodiment of the present disclosure is expected to be used as a substitute for existing petroleum-based plastics, and thus to have applications to across industries, including disposable products, various containers (cosmetics, medical), agricultural products, household goods, automobiles (interior materials), and clothing. It is expected that biodegradable bioplastics will be able to secure competitiveness over existing plastic products through the launch of competitive biodegradable bioplastic products through this technology.

In addition, in terms of utilizing waste resources, the blend composition according to an embodiment of the present disclosure is expected to be able to solve various social and environmental problems such as microplastic problem, carbon discharge problem, and food waste discharge problem.

Effects of the present disclosure are not limited to the above-mentioned effects, and other effects as not mentioned will be clearly understood by those skilled in the art from following descriptions.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a flowchart showing a method for preparing a blend composition with improved plasticity performance according to an embodiment of the present disclosure.

FIG. 2 shows a flowchart illustrating a method for extracting a first component containing suberin or suberin-based compound from a cork and a potato periderm in the method for preparing the blend composition with improved plasticity performance according to an embodiment of the present disclosure.

FIG. 3 is a photograph of each of suberin fatty acid and suberin ester in the preparation process of the blend composition with improved plasticity performance according to an embodiment of the present disclosure.

FIG. 4 shows a flowchart illustrating a method for blending the first component containing suberin ester and a second component containing polylactic acid with each other in the method for preparing the blend composition with improved plasticity performance according to an embodiment of the present disclosure.

FIG. 5 is a diagram showing circulation of resources in the method for preparing the blend composition with improved plasticity performance according to an embodiment of the present disclosure.

FIG. 6 is a photograph of a biodegradation state of the prepared blend composition over time.

### DETAILED DESCRIPTION

Advantages and features of the present disclosure, and a method of achieving the advantages and features will become apparent with reference to embodiments described later in detail together with the accompanying drawings. However, the present disclosure is not limited to the embodiments as disclosed below, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

The features of the various embodiments of the present disclosure may be partially or entirely combined with each other, and may be technically associated with each other or operate with each other. The embodiments may be implemented independently of each other and may be implemented together in an association relationship.

In interpreting a numerical value, the value is interpreted as including an error range unless there is no separate explicit description thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “embodiments,” “examples,” “aspects, and the like should not be construed such that any aspect or design as described is superior to or advantageous over other aspects or designs.

Further, the term ‘or’ means ‘inclusive or’ rather than ‘exclusive or’. That is, unless otherwise stated or clear from the context, the expression that ‘x uses a or b’ means any one of natural inclusive permutations.

The terms used in the description below have been selected as being general and universal in the related technical field. However, there may be other terms than the terms depending on the development and/or change of technology, convention, preference of technicians, etc. Therefore, the terms used in the description below should not be understood as limiting technical ideas, but should be understood as examples of the terms for describing embodiments.

A blend composition with improved plasticity performance according to an embodiment of the present disclosure includes a first component containing suberin or a suberin-based compound; and a second component containing polylactic acid (PLA).

In the context of the present disclosure, the suberin refers to a type of biopolymer that constitutes a plant epidermis and a plant epidermal cell wall. In the context of the present disclosure, the suberin-based compound refers to a compound derived from the suberin and having a similar chemical formula to that of the suberin, especially a compound having change in a functional group at a chain end of the suberin and a combination thereof. Non-limiting examples of the suberin-based compound include suberin fatty acids and suberin esters.

As described above, the suberin is the type of the biopolymer that constitutes the plant epidermis and the plant epidermal cell wall. Thus, the suberin may be extracted from the plant. In one embodiment, the first component may be extracted from plants or processed products thereof. There are no particular limitations on the plant or the processed product thereof as long as the suberin may be extracted therefrom. In one embodiment, the first component may be extracted from a cork or a potato periderm. In one embodiment, the first component may be extracted from a combination of the cork and the potato periderm.

The present disclosure is at least based on the discovery that it is possible to achieve high mechanical properties, etc. by controlling a content of the suberin or the suberin-based compound extracted from each of the cork and the potato periderm in the composition. In one embodiment, a ratio of a content (by weight) of the first component extracted from the cork and a content (by weight) of the first component extracted from the potato periderm may be in a range of about 2:1 to 3:1. In one embodiment, a ratio of a content (by weight) of the first component extracted from the cork and a content (by weight) of the first component extracted from the potato periderm may be in a range of about 10:90 to 1:99.

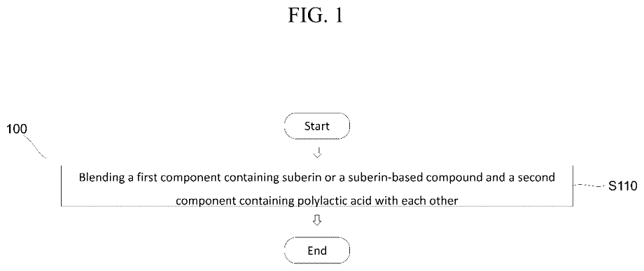

FIG. 1 is a flowchart showing a method for preparing a blend composition with improved plasticity performance according to an embodiment of the present disclosure.

Referring to FIG. 1, a method 100 for preparing a blend composition with improved plasticity performance according to an embodiment of the present disclosure may include a step S110 of blending the first component containing the suberin or the suberin-based compound and the second component containing the polylactic acid with each other.

A description about the method for preparing the blend composition with improved plasticity performance according to the embodiment of the present disclosure above may be applied equally or similarly to the same or similar contents in the description about the blend composition with improved plasticity performance according to an embodiment of the present disclosure as described above. Therefore, in one embodiment, the first component extracted from the cork and the first component extracted from the potato periderm may be blended with each other at a weight ratio of about 2:1 to 3:1. In one embodiment, the first component extracted from the cork and the first component extracted from the potato periderm may be blended with each other at a weight ratio of about 10:90 to 1:99. Furthermore, in one embodiment, a step of extracting the first component from a plant or a processed product thereof may be further included in the method 100. In one embodiment, the first component may be extracted from the cork or the potato periderm.

In one embodiment, the first component may be extracted from the combination of the cork and the potato periderm. In this regard, in one embodiment, the cork and the potato periderm from which the first component is to be extracted may be prepared at a weight ratio of about 4:6 to 6:4. In one example, the cork and the potato periderm from which the first component is to be extracted may be prepared in a weight ratio of about 5:5.

A process of extracting the first component containing the suberin or the suberin-based compounds from the cork and the potato periderm prepared as above is not particularly limited as long as the suberin or the suberin-based compounds may be extracted using the process.

In one embodiment, the cork and the potato periderms may be dried. In one example, the cork and the potato periderm may be dried at about 50° C. for about 8 hours.

In one embodiment, the dried cork and the dried potato periderm may be hydrolyzed. In one embodiment, the hydrolysis may be performed by adding a hydrolysis solution containing ethanol and sodium hydroxide thereto. In one example, the ethanol may be about 80% ethanol by weight. In one example, the sodium hydroxide may be used in an amount of about 0.1 to 0.3 times of a weight of each of the cork and the potato periderm.

In one embodiment, a hydrolysis result may be filtered. In one example, the filtering may be performed using a filter paper. In one example, the filter paper may have pores of about 10 to 13 μm. In one example, the filtering may be performed using the filter paper and a vacuum.

In one embodiment, the hydrolyzed or filtered product may be evaporated. In one example, the evaporation may be carried out at about 60 to 80° C. In one example, the evaporation may be performed in a rotary evaporator. In one example, the evaporation may be carried out at about 10 rpm in a rotary evaporator. In one example, the evaporation may optionally be carried out under vacuum in a rotary evaporator.

In one embodiment, the hydrolysis, filtering, or evaporation result may be coagulated. In one example, the coagulation may be carried out by adding a sulfuric acid solution thereto. In one example, the sulfuric acid solution may be a sulfuric acid solution of about 10% by volume. In one example, the coagulation may be carried out at 60 to 80° C. In one example, the coagulation may be carried out for about 1 hour.

In one embodiment, the hydrolysis, filtering, evaporation, or coagulation result may be washed and dried. In one example, the drying may be carried out via freeze drying. In one example, the drying may be carried out for about 2 to 4 days.

In one embodiment, the hydrolyzed, filtered, evaporated, coagulated, washed or dried product may contain suberin fatty acid.

In one embodiment, diethylene glycol may be added to the resulting product containing the suberin fatty acid. In one example, a content of the diethylene glycol may be in a range of about 5 to 10% by weight.

In one embodiment, the resulting product containing the suberin fatty acid may be subjected to polycondensation. In one embodiment, the first component may be extracted by hydrolyzing the cork or the potato periderm and then performing the polycondensation thereon. In one embodiment, the polycondensation may be performed at about 80 to 120° C. In one embodiment, the polycondensation may be carried out for about 36 to 60 hours.

In one embodiment, the blending may include blending the first component containing the suberin ester and the second component containing the polylactic acid with each other.

In one embodiment, the first component and the second component may be dried prior to the blending. In one example, the drying may be performed at about 60 to 100° C. In one example, the drying may be carried out for about 6 to 10 hours.

In one embodiment, the dried results may be blended with each other. In one embodiment, the blending may be carried out at about 160 to 200° C. In one embodiment, the blending may be carried out for about 5 minutes or larger.

In one embodiment, the dried or blended result may be molded. In one example, the molding may be performed at about 160 to 200° C.

In one embodiment, the dried, blended, or molded result may be subjected to twin screw extruding. In one example, the twin screw extrusion may be performed while heating the result at about 170 to 200° C. and cooling the result. In one embodiment, the method for preparing the blend composition with improved plasticity performance according to an embodiment of the present disclosure further includes a step of performing the twin screw extruding while heating the result at about 170 to 200° C. and cooling the result.

Hereinafter, examples of the present disclosure are described in detail. However, the examples as described below are only some embodiments of the present disclosure, and the scope of the present disclosure is not limited to the examples below.

### Preparing Example

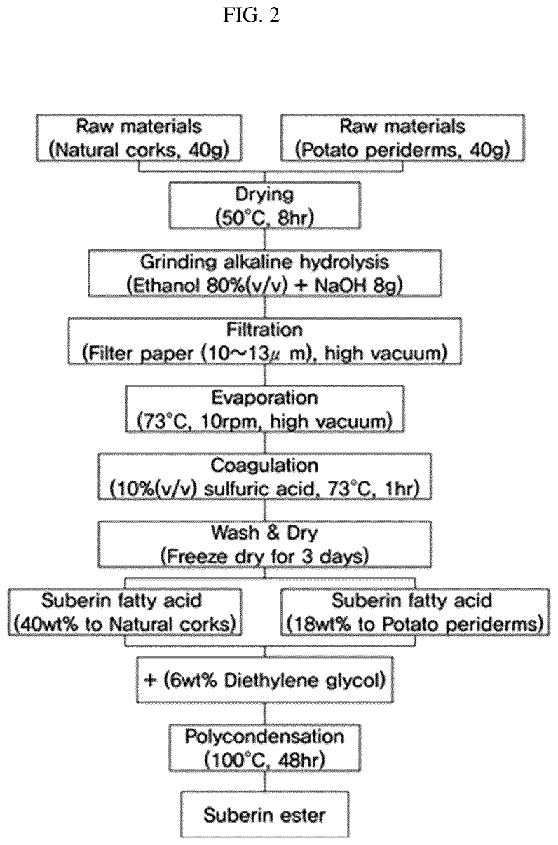

FIG. 2 shows a flowchart illustrating a method for extracting a first component containing suberin or suberin-based compound from a cork and a potato periderm in the method for preparing the blend composition with improved plasticity performance according to an embodiment of the present disclosure.

Referring to FIG. 2, 40 g of the cork and 40 g of the potato periderm were prepared. Each of the cork and the potato periderm was dried at 50° C. for 8 hours. The dried result was hydrolyzed in 80 vol % ethanol and 8 g of sodium hydroxide. In other words, this was performed via alkaline hydrolysis without using toxic solvents. The hydrolyzed product was filtered by applying a vacuum to a filter paper with pores of 10 to 13 μm. Thus, lignocelllosic particles were removed therefrom. The filtered result was evaporated in a rotary evaporator at 73° C. at 10 rpm under vacuum. 10% by volume of sulfuric acid was added to the evaporated result. Thus, the evaporated result was coagulated at 73° C. for 1 hour. The coagulation result was washed and dried for 3 days in the freeze-drying manner. 6% by weight diethylene glycol was optionally added to the resulting suberin fatty acid. Afterwards, polycondensation was performed thereon at 100° C. for 48 hours to prepare the suberin ester.

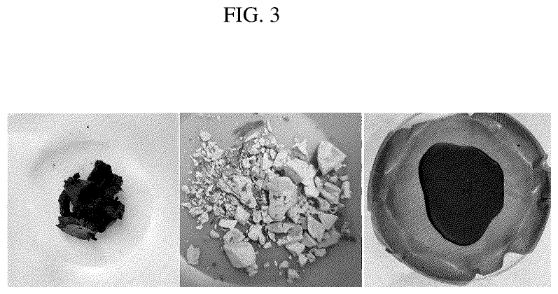

FIG. 3 is a photograph of each of suberin fatty acid and suberin ester in the preparation process of the blend composition with improved plasticity performance according to an embodiment of the present disclosure. In FIG. 3, the left photo relates to the suberin fatty acid extracted from the cork, the middle photo relates to the suberin fatty acid extracted from the potato periderm, and the right photo relates to the suberin ester prepared through polycondensation.

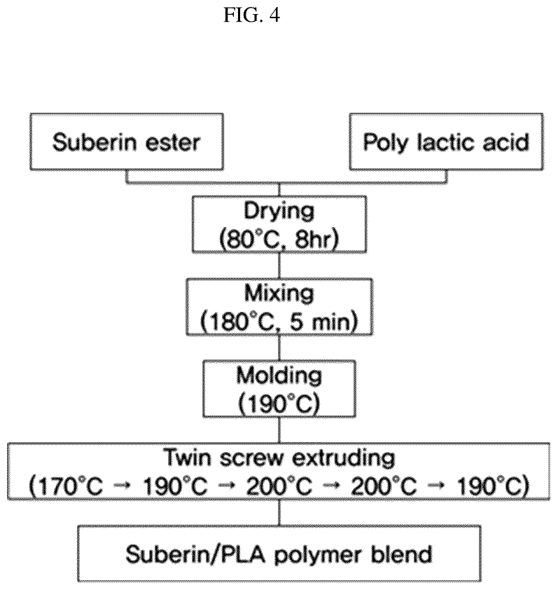

FIG. 4 shows a flowchart illustrating a method for blending the first component containing suberin ester and a second component containing polylactic acid with each other in the method for preparing the blend composition with improved plasticity performance according to an embodiment of the present disclosure.

Referring to FIG. 4, each of the first component containing the suberin ester and the second component containing polylactic acid was dried at 80° C. for 8 hours. The dried results were mixed with each other at 180° C. for 5 minutes. The mixing was performed using a Haake rheometer. The mixing result was molded at 190° C. The molding result was subjected to the twin screw extruding while heating the result to 170° C., 190° C., 200° C., and 190° C. and cooling the result alternately with each other. As a result, the blend composition with improved plasticity performance according to the example of the present disclosure was prepared.

In this regard, the first component containing the suberin ester and the second component containing the polylactic acid were blended with each other according to the contents in the table 1 below.

TABLE 1

| | Examples | | | | | | | | |
|---|---|---|---|---|---|---|---|---|---|
| | Preparing | Preparing | Preparing | Preparing | Preparing | Preparing | Preparing | Preparing | Preparing |
| | Example 1 | Example 2 | Example 3 | Example 4 | Example 5 | Example 6 | Example 7 | Example 8 | Example 9 |
| PLA | 100 | 99 | 97 | 95 | 90 | 99 | 97 | 95 | 90 |
| Cork-based suberin | — | 1 | 3 | 5 | 10 | — | — | — | — |
| Potato periderm-based | — | — | — | — | — | 1 | 3 | 5 | 10 |
| suberin | | | | | | | | | |

In Preparing Example 1 to Preparing Example 4 and Preparing Example 6 to Preparing Example 8, the suberin and PLA are mixed with each other well and evenly, whereas in Preparing Example 5 and Preparing Example 9, the suberin is not evenly mixed with PLA and is melt and flows out of the resin.

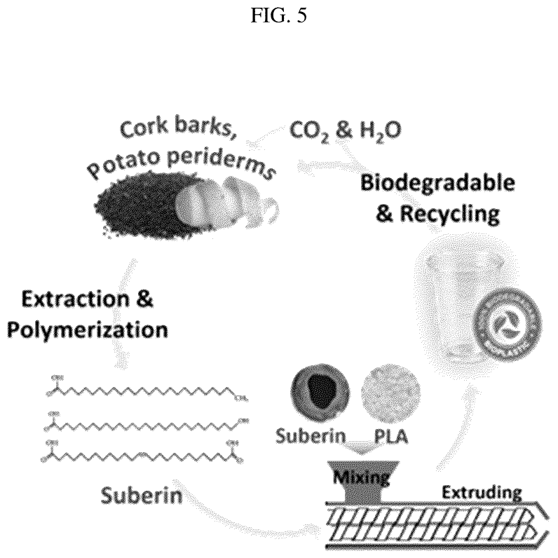

FIG. 5 is a diagram showing circulation of resources in a method for preparing a blend composition with improved plasticity performance according to an embodiment of the present disclosure. The blend composition may be prepared using the polylactic acid and the suberin derived from plants such as the cork or potato periderm, and the prepared blend composition may be biodegradable. Thus, the blend composition may be decomposed and used for plant growth.

### Experiment Examples

In order to evaluate the plasticization effect and physical properties of the prepared blend composition, the blend composition of each of Preparing Example 1 to Preparing Example 9 was formed into a film using a hot press at 190° C. and under a 2t load. The film was used as a specimen. Transparency, thermal deformation temperature, and biodegradation percentage were evaluated. Additionally, a tensile test specimen was obtained using an injection molding machine at 190° C. The results of testing the mechanical properties, thermal properties, and biodegradability of each of Preparing Examples are shown in a table 2 below.

TABLE 2

| Examples | | | | | | | | |
|---|---|---|---|---|---|---|---|---|
| Preparing | Preparing | Preparing | Preparing | Preparing | Preparing | Preparing | Preparing | Preparing |
| Example 1 | Example 2 | Example 3 | Example 4 | Example 5 | Example 6 | Example 7 | Example 8 | Example 9 |

Mechanical properties

| | | | | | | | | | |
|---|---|---|---|---|---|---|---|---|---|
| Tensile strength (MPa) | 60.7 | 61.0 | 54.7 | 44.6 | — | 57.9 | 48.2 | 42.6 | — |
| Elasticity coefficient | | | | | — | | | | — |
| (MPa) | | | | | | | | | |
| Elongation at break (%) | 2.4 | 3.3 | 12.7 | 10.8 | — | 4.1 | 12.6 | 20.8 | — |
| Transparency (%) | 100 | 85.8 | 82.0 | 41.5 | — | 84.5 | 73.0 | 59.9 | — |

Thermal properties

| | | | | | | | | | |
|---|---|---|---|---|---|---|---|---|---|
| Glass transition | 58.4 | 57.3 | 53.5 | 52.3 | — | 54.7 | 50.9 | 48.6 | — |
| temperature (° C./DSC) | | | | | | | | | |
| Glass transition | 61.3 | 57.9 | 56.5 | 56.2 | — | 57.4 | 56.9 | 56.2 | — |
| temperature (° C./DMA) | | | | | | | | | |
| Thermal deformation | 54.1 | 54.4 | 53.6 | 52.6 | — | 53.7 | 52.8 | 52.7 | — |
| temperature (° C. @45 | | | | | | | | | |
| MPa) | | | | | | | | | |
| Melt fluidity (g/min, | 10.01 | 15.9 | 17.1 | 29.2 | — | 12.3 | 20.3 | 33.2 | — |
| 190° C.) | | | | | | | | | |

Biodegradability

| | | | | | | | | | |
|---|---|---|---|---|---|---|---|---|---|
| Biodegradation | 96.4 | — | 90.5 | — | — | — | 93.7 | — | — |
| percentage (%) | | | | | | | | | |

Referring to Table 2, based on the tensile test results, it is identified that the elongation at break of the blend composition containing the suberin extracted from the potato periderm and/or the cork increases by up to 8.6 times as the suberin content increases. In addition, based on differential thermal analysis and dynamic mechanical analysis, it is identified that the glass transition temperature is lowered as the suberin content increases. This is because as the suberin content increases, a free-volume between polymer chains is secured, resulting in fluidity at lower temperatures, and thus securing the plasticizing effect. The same effect is identified based on the result of increase in melt fluidity at 190° C. as a processing temperature of the suberin/polylactic acid blend.

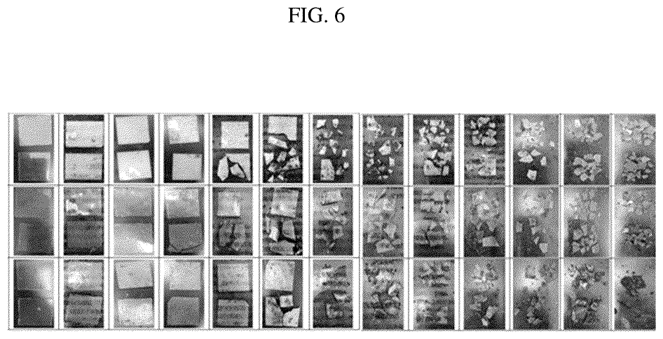

Continuing to refer to Table 2, based on the mechanical and thermal properties, it is identified that each of Preparing Example 3 and Preparing Example 7 which have the properties of elongation at break of 10% or greater, and thermal deformation temperature of 50° C. or higher, and transparency of 70% or greater has the most optimal contents. Accordingly, in order to identify the biodegradability of Preparing Example, biodegradation percentage analysis according to ISO20200 standards is performed. Thus, it is identified that all samples are decomposed by more than 90% within 12 weeks. FIG. 6 is a photo of the biodegradation state of the prepared blend composition over time. An upper photo is directed to the biodegradation state of the prepared blend composition of Preparing Example 1. A middle photo is directed to the biodegradation state of the prepared blend composition of Preparing Example 3. A lower photo is directed to the biodegradation state of the prepared blend composition of Preparing Example 7.

Therefore, it is identified that, compared to the petrochemical-based non-degradable plasticizer used to increase the processability of existing biodegradable polylactic acid, processability may be improved by increasing the ductility and elongation of the polylactic acid by using the suberin component extracted from natural resources, that is, the cork and the potato periderm, and, further, environmental friendliness was secured in addition to the mechanical properties.

Although the embodiments of the present disclosure have been described in more detail with reference to the accompanying drawings, the present disclosure is not necessarily limited to these embodiments, and may be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects.

What is claimed is:

1. A blend composition with improved plasticity performance, the blend composition comprising:
a first component containing suberin or a suberin-based compound; and
a second component containing polylactic acid (PLA).

2. The blend composition with improved plasticity performance of claim 1, wherein the first component is extracted from a plant or a process product of the plant.

3. The blend composition with improved plasticity performance of claim 2, wherein the first component is extracted from a cork and/or a potato periderm.

4. The blend composition with improved plasticity performance of claim 3, wherein the first component is extracted from the cork and the potato periderm,
wherein the first component extracted from cork and the first component extracted from the potato periderm have a weight ratio of 2:1 to 3:1.

5. The blend composition with improved plasticity performance of claim 1, wherein the first component and the second component have a weight ratio of 10:90 to 1:99.

6. A method for preparing a blend composition with improved plasticity performance, the method comprising:
blending a first component containing suberin or a suberin-based compound and a second component containing polylactic acid with each other.

7. The method of claim 6, wherein the first component and the second component are blended with each other at a weight ratio of 10:90 to 1:99.

8. The method of claim 6, wherein the method further comprises extracting the first component from a plant or a processed product of the plant.

9. The method of claim 8, wherein the first component is extracted from a cork and/or a potato periderm.

10. The method of claim 9, wherein the first component is extracted from the cork and the potato periderm,
wherein the cork and the potato periderm from which the first component is to be extracted are prepared at a weight ratio of 4:6 to 6:4.

11. The method of claim 9, wherein the first component is extracted from the cork and the potato periderm by hydrolyzing the cork and/or the potato periderm and then performing polycondensation on the hydrolyzed cork and/or the hydrolyzed potato periderm.

12. The method of claim 11, wherein the hydrolysis is carried out by adding a hydrolysis solution containing ethanol and sodium hydroxide to the cork and/or the potato periderm.

13. The method of claim 11, wherein the polycondensation is carried out at 80 to 120° C. for 36 to 60 hours.

14. The method of claim 6, wherein the blending is carried out at 160 to 200° C. for 5 minutes or greater.

15. The method of claim 6, wherein the method further comprises performing twin-screw extruding of a blending result while heating the blending result at 170 to 200° C. and cooling the blending result alternately with each other.
